(19) United States
(12) Patent Application Publication
(10) Pub. No.: US 2025/0053823 A1
(43) Pub. Date: Feb. 13, 2025

(54) SYSTEMS AND METHODS FOR TRAINING REINFORCEMENT LEARNING MODELS USING UNSUPERVISED MODELS

(71) Applicant: Capital One Services, LLC, McLean, VA (US)

(72) Inventor: Blake HAMM, McLean, VA (US)

(73) Assignee: Capital One Services, LLC, McLean, VA (US)

(21) Appl. No.: 18/448,896

(22) Filed: Aug. 11, 2023

(51) Int. Cl. G06N 3/092; G06N 3/045; G06N 10/60

(52) U.S. Cl. CPC G06N 3/092; G06N 3/045; G06N 10/60

(57) ABSTRACT

Methods and systems for training a reinforcement learning model using training data generated using an unsupervised model. In some aspects, the system processes a first unlabeled dataset using an unsupervised model to generate a first set of labels associated with statistical properties of the first unlabeled dataset. The system generates a labeled training dataset using the first set of labels and the first unlabeled dataset. The system uses the labeled training dataset to train a reinforcement learning model to identify abnormalities and changes to statistical distributions within data. The system uses the reinforcement learning model to process a second unlabeled dataset to generate a second set of labels associated with statistical properties of the second unlabeled dataset.

### SUMMARY

Reinforcement learning models benefit greatly from abundant and high-quality training data. However, training data for many applications of reinforcement learning is scarce and ensuring data quality is especially difficult. Common workflows for training machine learning models and in particular reinforcement learning models often suffer from data availability and/or quality problems, resulting in models that perform sub-optimally.

Methods and systems are described herein for novel uses and/or improvements to artificial intelligence applications and in particular to using unsupervised learning models to generate or supplement training data for a reinforcement learning model in such contexts as changepoint detection for time-series data. Existing systems have not contemplated using unsupervised learning models to provide informed, salient, and bias-free training data for reinforcement learning models. In some aspects, the system may use an unsupervised learning model to process an unlabeled dataset and generate a set of labels. The system may generate a labeled training dataset by mapping the labels to the unlabeled dataset. The labeled dataset may serve as training data for a reinforcement learning model. The reinforcement learning model may identify abnormalities and changes to statistical distributions within input data. Doing so provides the advantage of creating a reliable basis of training data upon which the reinforcement learning can be tuned further.

In some aspects, a method for training a reinforcement learning model using training data generated using an unsupervised model is disclosed herein, the method comprising: processing a first unlabeled dataset using an unsupervised model to generate a first set of labels associated with statistical properties of the first unlabeled dataset; using the first set of labels and the first unlabeled dataset, generating a labeled training dataset; using the labeled training dataset, training a reinforcement learning model to identify abnormalities and changes to statistical distributions within data; and using the reinforcement learning model, processing a second unlabeled dataset to generate a second set of labels associated with statistical properties of the second unlabeled dataset.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for training a reinforcement learning model using training data generated using an unsupervised model, in accordance with one or more embodiments.

FIG. 2 show an illustration of time-series data processed by one or more models to identify changepoints, in accordance with one or more embodiments.

FIG. 3 shows illustrative components for a system for training a reinforcement learning model using training data generated using an unsupervised model, in accordance with one or more embodiments.

FIG. 4 shows a flowchart of the steps involved in training a reinforcement learning model using training data generated using an unsupervised model, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

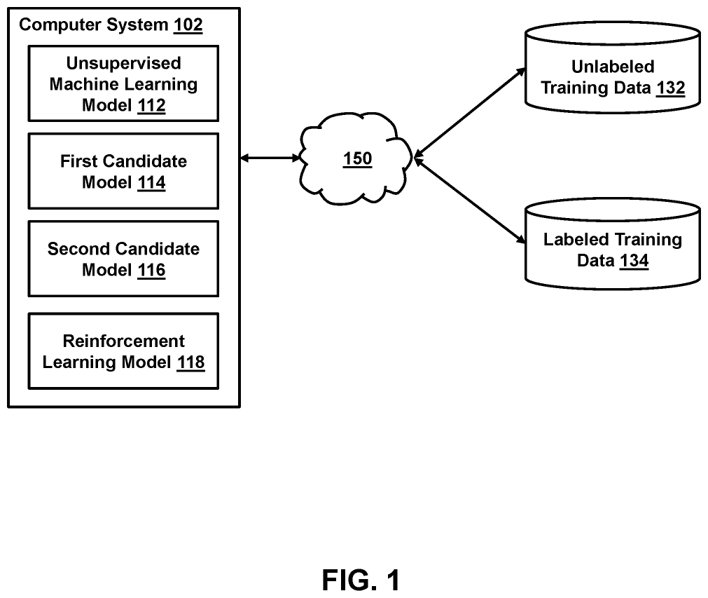

FIG. 1 shows an illustrative diagram for system 150, which contains hardware and software components used for training a reinforcement learning model using training data generated using an unsupervised model, in accordance with one or more embodiments. For example, Computer System 102, a part of system 150, may include Unsupervised Machine Learning Model 112, First Candidate Model 114, and Second Candidate Model 116. Additionally, system 150 may create, store, and use Unlabeled Training Data 132 and Labeled Training Data 134 in one or more contexts.

The system (e.g., system 150) may receive a raw training dataset (e.g., Unlabeled Training Data 132). Unlabeled Training Data 132 may, for example, be a matrix of real values. Each row in the matrix may correspond to an instance of data, including a set of features values for which are real numbers. In some embodiments, a feature in Unlabeled Training Data 132 may be a timestamp, and Unlabeled Training Data 132 may be time-series data. In some embodiments, Unlabeled Training Data 132 may be a series of data updates, each of which corresponds to a time when the data update is received by the system or generated. As an example, Unlabeled Training Data 132 may be a time-series dataset describing changes to a user system's resource consumption. In this example, features in Unlabeled Training Data 132 may include the user system's make and model, the user system's location, the membership of the user system in any networks, any allocations of resources to the user system, a length of time for which the user system has recorded resource consumption, an extent and frequency of resource consumption, and the number of instances of the user system's excessive resource consumption. Each entry in Unlabeled Training Data 132 may be associated with a timestamp. Thus, Unlabeled Training Data 132 may contain, for example, daily changes to resource consumption levels and associated metrics for a user system.

In some embodiments, the system may, before retrieving Unlabeled Training Data 132, process part or all of the data using a data cleansing process to generate a processed dataset. The data cleansing process may include standardizing data types, formatting and units of measurement, and removing duplicate data.

In some embodiments, the system may supplement Unlabeled Training Data 132 with synthetic data, which may be of the same format as Unlabeled Training Data 132. The synthetic data may be generated using a predetermined or randomized process and may correspond to hypothetical scenarios not captured in Unlabeled Training Data 132, for example.

In some embodiments, the system may process Unlabeled Training Data 132 to generate data profiles, each of which correspond to a data update. A data profile describing a data update (e.g., including a first set of features) may include descriptive statistics regarding the data update. For example, the data profile may include a vector of averages across the first set of features in the data update. For example, the data profile may include distributions of the first set of features in the data update. For example, the data profile may include a list of frequencies of null values for the first set of features. For example, the data profile may include a covariance matrix between the first set of features. In some embodiments, the data profile may additionally or alternatively project datasets in Unlabeled Training Data 132 into an alternate coordinate system. In some embodiments, the system may receive Unlabeled Training Data 132 as a stream of data updates over a period of time, each data update including a unique dataset, for example representing a snapshot of some evolving process such as a disease. Correspondingly, the plurality of data updates in Unlabeled Training Data 132 may represent changes to the training data for the local model over time.

In some embodiments, the system may divide Unlabeled Training Data 132 into one or more portions. For example, each entry in Unlabeled Training Data 132 may be randomly placed into a first portion or a second portion. Each portion thus contains half the entries in Unlabeled Training Data 132 in a non-sequential, randomized manner. Each portion of data in Unlabeled Training Data 132 may be associated with a weight score. The weight score may, for example, represent what proportion of Unlabeled Training Data 132 was assigned to a portion. The weight scores may be used in combining parameters from candidate models each of which processed a portion of Unlabeled Training Data 132. In some embodiments, the system may divide Unlabeled Training Data 132 using a bias metric relating to preferences for one candidate model over another, for example due to algorithms used in the candidate models. For example, the system may divide Unlabeled Training Data 132 into three portions containing equal numbers of entries but assign a first portion a weight score of 0.5, a second portion a weight score of 0.3, and a third portion a weight score of 0.2. Each portion may then be processed by a candidate model.

The system may use an unsupervised model (e.g., Unsupervised Machine Learning Model 112) to process Unlabeled Training Data 132 and generate a first set of labels. For example, Unlabeled Training Data 132 may be a time-series dataset. Unsupervised Machine Learning Model 112 may use a Bayesian network to perform changepoint detection on time-series data and generate timestamps corresponding to points in time-series data where a statistical distribution has shifted. For example, Unlabeled Training Data 132 may correspond, in an early portion, to a normally-distributed dataset with a mean of 20. After a point in time which may represent the end of this early portion, Unlabeled Training Data 132 may instead be closer to an exponential distribution with a mean of 30. Unsupervised Machine Learning Model 112 may identify this point in time as a changepoint. Unsupervised Machine Learning Model 112 may use algorithms such as gradient boosting, adaptive boosting, random forests, among others, to perform changepoint detection, anomaly detection, or other classification tasks. Unsupervised Machine Learning Model 112 may be trained on data separate from Unlabeled Training Data 132.

In some embodiments, Unsupervised Machine Learning Model 112 may be generated by training a first candidate model (e.g., First Candidate Model 114) and a second candidate model (e.g., Second Candidate Model 116). First Candidate Model 114 and Second Candidate Model 116 may be trained on raw training data distinct from Unlabeled Training Data 132. The raw training data may be of the same or a similar format as Unlabeled Training Data 132 and may be divided into portions using a process like the one described above. For example, First Candidate Model 114 may be trained on a first portion of the raw training data and Second Candidate Model 116 may be trained on a second portion of the raw training data. First Candidate Model 114 and Second Candidate Model 116 may, for example, both be decision trees in a random forests method. Because the candidate models are trained independently on separate sets of training data, each candidate model may rectify the tendency of the other model to overfit. Unsupervised Machine Learning Model 112 may be generated by combining First Candidate Model 114 and Second Candidate Model 116. For example, the output of Unsupervised Machine Learning Model 112 may be a weighted average of First Candidate Model 114 and Second Candidate Model 116.

In some embodiments, the system may instead train both First Candidate Model 114 and Second Candidate Model 116 on the full set of raw training data. For example, First Candidate Model 114 and Second Candidate Model 116 may use different algorithms or loss functions such that the models are differentiated even when trained on the same training data. For example, First Candidate Model 114 may use a learning rate of 0.5 in Q-learning while Second Candidate Model 116 may use a learning rate of 0.7. For example, First Candidate Model 114 may use a Bayesian prior different from Second Candidate Model 116, even though both models use the Bayesian network algorithm. After the system trains First Candidate Model 114 and Second Candidate Model 116 on the raw training data, the system may combine the parameters of First Candidate Model 114 and Second Candidate Model 116 to generate Unsupervised Machine Learning Model 112. In some embodiments, the parameters of First Candidate Model 114 and Second Candidate Model 116 may be combined according to a first bias metric. For example, the system may be programmed to prioritize algorithms and hyperparameters selected for First Candidate Model 114 over those for Second Candidate Model 116. Therefore, the system may combine parameters of First Candidate Model 114 and Second Candidate Model 116 in a ratio of 8:2 for each parameter.

In some embodiments, the system may randomly divide the raw training data into a training set and a validation set. The system may train both First Candidate Model 114 and Second Candidate Model 116 on the training set. The system may then obtain cross-validation error rates for each of First Candidate Model 114 and Second Candidate Model 116 by testing both models on the validation set. Using the cross-validation error rates, the system may determine weights for combining parameters of First Candidate Model 114 and Second Candidate Model 116 to generate Unsupervised Machine Learning Model 112. For example, if the cross-validation error rate for First Candidate Model 114 is determined to be 0.86 and the cross-validation error rate for Second Candidate Model 116 is 0.34, the system may select parameters for Unsupervised Machine Learning Model 112 by taking a weighted average of parameters of First Candidate Model 114 and Second Candidate Model 116. The weights may be 0.283 and 0.717, inversely corresponding to the cross-validation error rates of First Candidate Model 114 and Second Candidate Model 116.

The system may process Unlabeled training Data 132 using Unsupervised Machine Learning Model 112 to generate Labeled Training Data 134. For example, Unlabeled Training Data 132 may be a time-series data tracking changes to a set of variables over a period of time. Unsupervised Machine Learning Model 112 may be a changepoint detection model, which identifies points in time-series data where the statistical distributions of the underlying variables change. By processing Unlabeled Training Data 132, Unsupervised Machine Learning Model 112 may output a set of labels corresponding to changepoints where distributions of one or more variables in Unlabeled Training Data 132 changed. For example, the distribution may have a different mean or standard variation, as interpreted by Unsupervised Machine Learning Model 112. The set of labels may be mapped to timestamps within Unlabeled Training Data 132 to generate Labeled Training Data 134. In another embodiment, Unlabeled Training Data 132 may be a series of data updates, all with the same set of features. Some of the data updates may be abnormal, for example due to data quality being compromised or maliciously rewritten. Unsupervised Machine Learning Model 112 may output a set of labels corresponding to the data updates within Unlabeled Training Data 132 deemed abnormal. By combining the set of labels with Unlabeled Training Data 132, the system may generate Labeled Training Data 134. Labeled Training Data 134 may be used to train a machine learning model using its set of labels.

The system may train a reinforcement learning model (e.g., Reinforcement Learning Model 118) using Labeled Training Data 134. Reinforcement Learning Model 118 may, for example, be a Q-learning algorithm which performs changepoint detection. Reinforcement Learning Model 118 may alternatively be a deep reinforcement learning algorithm performing anomaly detection, for example. Reinforcement Learning Model 118 may be trained using Labeled Training Data 134, for example through a Markov Decision Process framework. Alternatively or additionally, Reinforcement Learning Model 118 may be a deep reinforcement neural network, trained by iteratively applying dynamic programming to a Q-learning reinforcement in an environment based on labels in Labeled Training Data 134. Reinforcement Learning Model 118 may generate a second set of labels corresponding to Labeled Training Data 134, distinct from the first set of labels contained in Labeled Training Data 134 which was used to train Reinforcement Learning Model 118. In some embodiments, the second set of labels and the first set of labels may serve as a loss function to train Reinforcement Learning Model 118. In some embodiments, subsequently to training Reinforcement Learning Model 118 using Labeled Training Data 134, the system may process a second unlabeled dataset distinct from both Labeled Training Data 134 and Unlabeled Training Data 132 using Reinforcement Learning Model 118 to generate a second set of labels. The second set of labels in these embodiments may, for example, represent changepoints or anomalies within the second unlabeled dataset.

In some embodiments, the system may transmit the second set of labels to users and collect feedback. For example, Reinforcement Learning Model 118 may generate a second set of labels corresponding to a set of changepoints within time-series data (i.e., input data). The set of labels and the input data may be shown to a set of users, who may have a priori knowledge of where changepoints are within the input data, for example. The system may collect from the users a third set of labels corresponding to the input data, the third set of labels generated by the users' knowledge. The system may record differences between the third set of labels and the second set of labels as a measure of discrepancy, and use the measure of discrepancy to re-train or update Reinforcement Learning Model 118. In some embodiments, the measure of discrepancy may be used as a performance metric of Reinforcement Learning Model 118, and the system may use the measure of discrepancy to update a bias metric. The bias metric may be used to generate Unsupervised Machine Learning Model 112 by combining First Candidate Model 114 and Second Candidate Model 116. Using the updated bias metric, the system may re-train or update Unsupervised Machine Learning Model 112. The system may use the updated Unsupervised Machine Learning Model 112 to generate a new set of data for Labeled Training Data 134. In some embodiments, the system may re-train Reinforcement Learning Model 118 using the new Labeled Training Data 134.

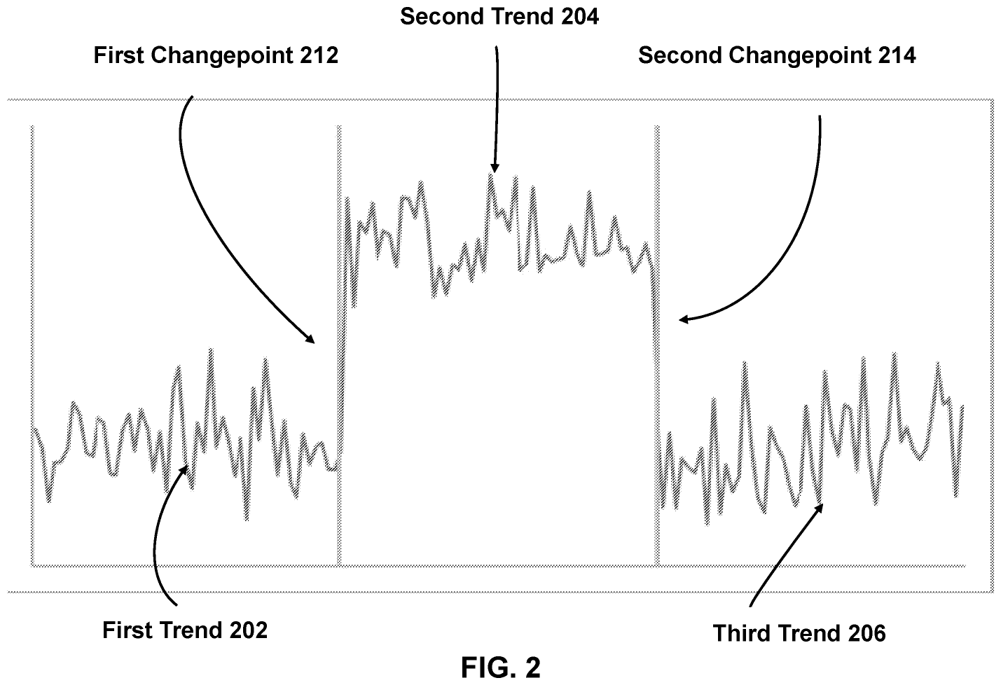

FIG. 2 is an illustration of time-series data with a set of labels corresponding to changepoints within the time-series data. FIG. 2 shows time-series changes to a variable over time. The data represented in FIG. 2 may, for example, be raw training data on which to train Unsupervised Machine Learning Model 112, or Unlabeled Training Data 132. With the addition of labels symbolizing changepoints in the time-series data, the data may be Labeled Training Data 134, or the output from Reinforcement Learning Model 118. The data may include three portions, First Trend 202, Second Trend 204, and Third Trend 206, all representing the same underlying variable at different periods of time. As may be observed, First Trend 202, Second Trend 204, and Third Trend 206 may be said to be drawn from different distributions. The means, standard deviations, and cyclical frequencies of the statistical distributions for First Trend 202, Second Trend 204, and Third Trend 206 seem to vary from one to the other. Additionally, due to the temporal sequence of First Trend 202 being followed in time by Second Trend 204 and then Third Trend 206, the data may be observed to have two changepoints. On FIG. 2 the changepoints are indicated as First Changepoint 212, when First Trend 202 leads into Second Trend 204, and Second Changepoint 214, when Second Trend 204 leads into Third Trend 206. In some embodiments, First Trend 202, Second Trend 204, and Third Trend 206 may be used as raw training data for First Candidate Model 114 and/or Second Candidate Model 116. For example, First Changepoint 212 and Second Changepoint 214 may be obscured from First Candidate Model 114 and Second Candidate Model 116 due to the unsupervised nature of these models. In other embodiments, Unsupervised Machine Learning Model 112 may process First Trend 202, Second Trend 204, and Third Trend 206 to generate First Changepoint 212 and Second Changepoint 214. The system may then integrate First Changepoint 212 and Second Changepoint 214 into First Trend 202, Second Trend 204, and Third Trend 206 to generate Labeled Training Data 134. In these embodiments, Reinforcement Learning Model 18 may be trained on First Trend 202, Second Trend 204, and Third Trend 206, using First Changepoint 212 and Second Changepoint 214 to guide the reinforcement learning process. In yet other embodiments, Reinforcement Learning Model 18 may process First Trend 202, Second Trend 204, and Third Trend 206 to generate First Changepoint 212 and Second Changepoint 214.

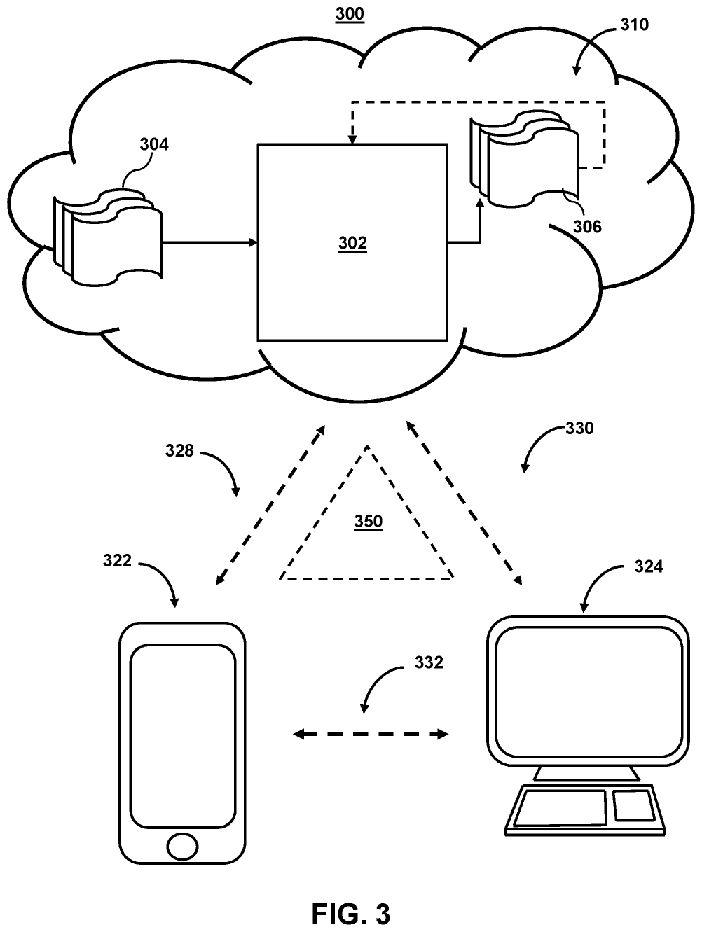

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict predicting resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

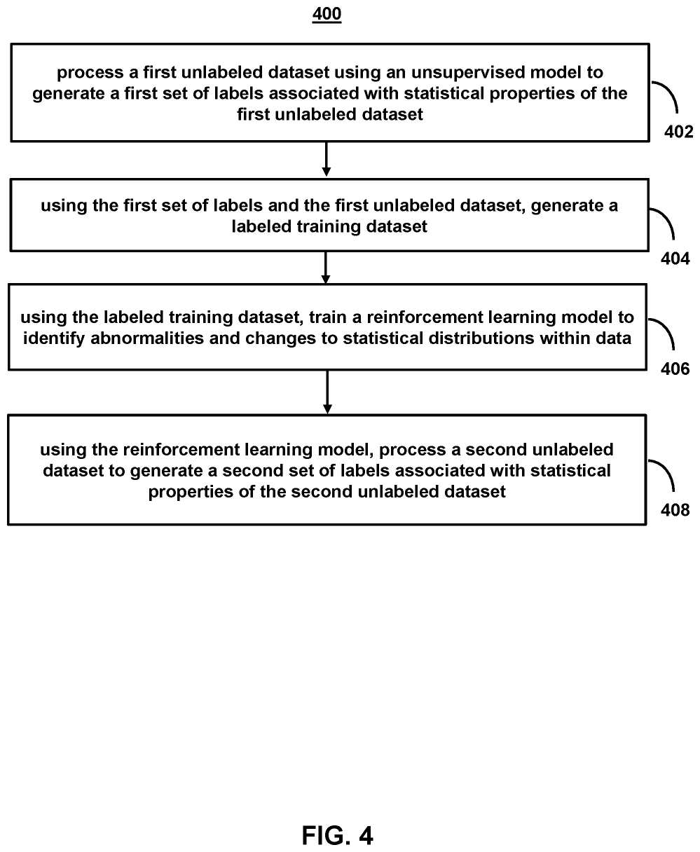

FIG. 4 shows a flowchart of the steps involved in training a reinforcement learning model using training data generated using an unsupervised model, in accordance with one or more embodiments. For example, the system may use process 400 (e.g., as implemented on one or more system components described above) in order to process an unlabeled dataset using an unsupervised model to generate a labeled dataset, train a reinforcement learning model using the labeled dataset, and deploy the reinforcement learning model for tasks such as anomaly detection or changepoint detection.

At step 402, process 400 (e.g., using one or more components described above) processes a first unlabeled dataset using an unsupervised model to generate a first set of labels associated with statistical properties of the first unlabeled dataset. The system (e.g., system 150) may receive a raw training dataset (e.g., Unlabeled Training Data 132). Unlabeled Training Data 132 may, for example, be a matrix of real values. Each row in the matrix may correspond to an instance of data, including a set of features values for which are real numbers. In some embodiments, a feature in Unlabeled Training Data 132 may be a timestamp, and Unlabeled Training Data 132 may be time-series data. In some embodiments, Unlabeled Training Data 132 may be a series of data updates, each of which corresponds to a time when the data update is received by the system or generated. As an example, Unlabeled Training Data 132 may be a time-series dataset describing changes to a user system's resource consumption. In this example, features in Unlabeled Training Data 132 may include the user system's make and model, the user system's location, the membership of the user system in any networks, any allocations of resources to the user system, a length of time for which the user system has recorded resource consumption, an extent and frequency of resource consumption, and the number of instances of the user system's excessive resource consumption. Each entry in Unlabeled Training Data 132 may be associated with a timestamp. Thus Unlabeled Training Data 132 may contain, for example, daily changes to resource consumption levels and associated metrics for a user system.

In some embodiments, the system may, before retrieving Unlabeled Training Data 132, process part or all of the data using a data cleansing process to generate a processed dataset. The data cleansing process may include standardizing data types, formatting and units of measurement, and removing duplicate data.

In some embodiments, the system may supplement Unlabeled Training Data 132 with synthetic data, which may be of the same format as Unlabeled Training Data 132. The synthetic data may be generated using a predetermined or randomized process and may correspond to hypothetical scenarios not captured in Unlabeled Training Data 132, for example.

In some embodiments, the system may process Unlabeled Training Data 132 to generate data profiles, each of which correspond to a data update. A data profile describing a data update (e.g., including a first set of features) may include descriptive statistics regarding the data update. For example, the data profile may include a vector of averages across the first set of features in the data update. For example, the data profile may include distributions of the first set of features in the data update. For example, the data profile may include a list of frequencies of null values for the first set of features. For example, the data profile may include a covariance matrix between the first set of features. In some embodiments, the data profile may additionally or alternatively project datasets in Unlabeled Training Data 132 into an alternate coordinate system. In some embodiments, the system may receive Unlabeled Training Data 132 as a stream of data updates over a period of time, each data update including a unique dataset, for example representing a snapshot of some evolving process such as a disease. Correspondingly, the plurality of data updates in Unlabeled Training Data 132 may represent changes to the training data for the local model over time.

In some embodiments, the system may divide Unlabeled Training Data 132 into one or more portions. For example, each entry in Unlabeled Training Data 132 may be randomly placed into a first portion or a second portion. Each portion thus contains half the entries in Unlabeled Training Data 132 in a non-sequential, randomized manner. Each portion of data in Unlabeled Training Data 132 may be associated with a weight score. The weight score may, for example, represent what proportion of Unlabeled Training Data 132 was assigned to a portion. The weight scores may be used in combining parameters from candidate models each of which processed a portion of Unlabeled Training Data 132. In some embodiments, the system may divide Unlabeled Training Data 132 using a bias metric relating to preferences for one candidate model over another, for example due to algorithms used in the candidate models. For example, the system may divide Unlabeled Training Data 132 into three portions containing equal numbers of entries, but assign a first portion a weight score of 0.5, a second portion a weight score of 0.3, and a third portion a weight score of 0.2. Each portion may then be processed by a candidate model.

The system may use an unsupervised model (e.g., Unsupervised Machine Learning Model 112) to process Unlabeled Training Data 132 and generate a first set of labels. For example, Unlabeled Training Data 132 may be a time-series dataset. Unsupervised Machine Learning Model 112 may use a Bayesian network to perform changepoint detection on time-series data and generate timestamps corresponding to points in time-series data where a statistical distribution has shifted. For example, Unlabeled Training Data 132 may correspond, in an early portion, to a normally-distributed dataset with a mean of 20. After a point in time which may represent the end of this early portion, Unlabeled Training Data 132 may instead be closer to an exponential distribution with a mean of 30. Unsupervised Machine Learning Model 112 may identify this point in time as a changepoint. Unsupervised Machine Learning Model 112 may use algorithms such as gradient boosting, adaptive boosting, random forests, among others, to perform changepoint detection, anomaly detection, or other classification tasks. Unsupervised Machine Learning Model 112 may be trained on data separate from Unlabeled Training Data 132.

In some embodiments, Unsupervised Machine Learning Model 112 may be generated by training a first candidate model (e.g., First Candidate Model 114) and a second candidate model (e.g., Second Candidate Model 116). First Candidate Model 114 and Second Candidate Model 116 may be trained on raw training data distinct from Unlabeled Training Data 132. The raw training data may be of the same or a similar format as Unlabeled Training Data 132 and may be divided into portions using a process like the one described above. For example, First Candidate Model 114 may be trained on a first portion of the raw training data and Second Candidate Model 116 may be trained on a second portion of the raw training data. First Candidate Model 114 and Second Candidate Model 116 may, for example, both be decision trees in a random forests method. Because the candidate models are trained independently on separate sets of training data, each candidate model may rectify the tendency of the other model to overfit. Unsupervised Machine Learning Model 112 may be generated by combining First Candidate Model 114 and Second Candidate Model 116. For example, the output of Unsupervised Machine Learning Model 112 may be a weighted average of First Candidate Model 114 and Second Candidate Model 116.

In some embodiments, the system may instead train both First Candidate Model 114 and Second Candidate Model 116 on the full set of raw training data. For example, First Candidate Model 114 and Second Candidate Model 116 may use different algorithms or loss functions such that the models are differentiated even when trained on the same training data. For example, First Candidate Model 114 may use a learning rate of 0.5 in Q-learning while Second Candidate Model 116 may use a learning rate of 0.7. For example, First Candidate Model 114 may use a Bayesian prior different from Second Candidate Model 116, even though both models use the Bayesian network algorithm. After the system trains First Candidate Model 114 and Second Candidate Model 116 on the raw training data, the system may combine the parameters of First Candidate Model 114 and Second Candidate Model 116 to generate Unsupervised Machine Learning Model 112. In some embodiments, the parameters of First Candidate Model 114 and Second Candidate Model 116 may be combined according to a first bias metric. For example, the system may be programmed to prioritize algorithms and hyperparameters selected for First Candidate Model 114 over those for Second Candidate Model 116. Therefore, the system may combine parameters of First Candidate Model 114 and Second Candidate Model 116 in a ratio of 8:2 for each parameter.

In some embodiments, the system may randomly divide the raw training data into a training set and a validation set. The system may train both First Candidate Model 114 and Second Candidate Model 116 on the training set. The system may then obtain cross-validation error rates for each of First Candidate Model 114 and Second Candidate Model 116 by testing both models on the validation set. Using the cross-validation error rates, the system may determine weights for combining parameters of First Candidate Model 114 and Second Candidate Model 116 to generate Unsupervised Machine Learning Model 112. For example, if the cross-validation error rate for First Candidate Model 114 is determined to be 0.86 and the cross-validation error rate for Second Candidate Model 116 is 0.34, the system may select parameters for Unsupervised Machine Learning Model 112 by taking a weighted average of parameters of First Candidate Model 114 and Second Candidate Model 116. The weights may be 0.283 and 0.717, inversely corresponding to the cross-validation error rates of First Candidate Model 114 and Second Candidate Model 116.

At step 404, process 400 (e.g., using one or more components described above) generates a labeled training dataset using the first set of labels and the first unlabeled dataset. The system may process Unlabeled training Data 132 using Unsupervised Machine Learning Model 112 to generate Labeled Training Data 134. For example, Unlabeled Training Data 132 may be a time-series data tracking changes to a set of variables over a period of time. Unsupervised Machine Learning Model 112 may be a changepoint detection model, which identifies points in time-series data where the statistical distributions of the underlying variables change. By processing Unlabeled Training Data 132, Unsupervised Machine Learning Model 112 may output a set of labels corresponding to changepoints where distributions of one or more variables in Unlabeled Training Data 132 changed. For example, the distribution may have a different mean or standard variation, as interpreted by Unsupervised Machine Learning Model 112. The set of labels may be mapped to timestamps within Unlabeled Training Data 132 to generate Labeled Training Data 134. In another embodiment, Unlabeled Training Data 132 may be a series of data updates, all with the same set of features. Some of the data updates may be abnormal, for example due to data quality being compromised or maliciously rewritten. Unsupervised Machine Learning Model 112 may output a set of labels corresponding to the data updates within Unlabeled Training Data 132 deemed abnormal. By combining the set of labels with Unlabeled Training Data 132, the system may generate Labeled Training Data 134. Labeled Training Data 134 may be used to train a machine learning model using its set of labels.

At step 406, process 400 (e.g., using one or more components described above) trains a reinforcement learning model to identify abnormalities and changes to statistical distributions within data using the labeled training dataset. The system may train a reinforcement learning model (e.g., Reinforcement Learning Model 118) using Labeled Training Data 134. Reinforcement Learning Model 118 may, for example, be a Q-learning algorithm which performs changepoint detection. Reinforcement Learning Model 118 may alternatively be a deep reinforcement learning algorithm performing anomaly detection, for example. Reinforcement Learning Model 118 may be trained using Labeled Training Data 134, for example through a Markov Decision Process framework. Alternatively or additionally, Reinforcement Learning Model 118 may be a deep reinforcement neural network, trained by iteratively applying dynamic programming to a Q-learning reinforcement in an environment based on labels in Labeled Training Data 134.

At step 408, process 400 (e.g., using one or more components described above) processes a second unlabeled dataset to generate a second set of labels associated with statistical properties of the second unlabeled dataset using the reinforcement learning model. Reinforcement Learning Model 118 may generate a second set of labels corresponding to Labeled Training Data 134, distinct from the first set of labels contained in Labeled Training Data 134 which was used to train Reinforcement Learning Model 118. In some embodiments, the second set of labels and the first set of labels may serve as a loss function to train Reinforcement Learning Model 118. In some embodiments, subsequently to training Reinforcement Learning Model 118 using Labeled Training Data 134, the system may process a second unlabeled dataset distinct from both Labeled Training Data 134 and Unlabeled Training Data 132 using Reinforcement Learning Model 118 to generate a second set of labels. The second set of labels in these embodiments may, for example, represent changepoints or anomalies within the second unlabeled dataset.

In some embodiments, the system may transmit the second set of labels to users and collect feedback. For example, Reinforcement Learning Model 118 may generate a second set of labels corresponding to a set of changepoints within time-series data (i.e., input data). The set of labels and the input data may be shown to a set of users, who may have a priori knowledge of where changepoints are within the input data, for example. The system may collect from the users a third set of labels corresponding to the input data, the third set of labels generated by the users' knowledge. The system may record differences between the third set of labels and the second set of labels as a measure of discrepancy and use the measure of discrepancy to re-train or update Reinforcement Learning Model 118. In some embodiments, the measure of discrepancy may be used as a performance metric of Reinforcement Learning Model 118, and the system may use the measure of discrepancy to update a bias metric. The bias metric may be used to generate Unsupervised Machine Learning Model 112 by combining First Candidate Model 114 and Second Candidate Model 116. Using the updated bias metric, the system may re-train or update Unsupervised Machine Learning Model 112. The system may use the updated Unsupervised Machine Learning Model 112 to generate a new set of data for Labeled Training Data 134. In some embodiments, the system may re-train Reinforcement Learning Model 118 using the new Labeled Training Data 134.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving a first time-series dataset; processing the first time-series dataset using an unsupervised model to generate a set of changepoints in the first time-series dataset; using the first time-series dataset and the set of changepoints, generating a first training dataset; using the first training dataset, training a reinforcement learning model to identify changepoints in time-series data; and using the reinforcement learning model, processing a second time-series dataset to generate one or more notifications comprising changepoints in the second time-series dataset.
2. A method comprising: processing a first unlabeled dataset using an unsupervised model to generate a first set of labels associated with statistical properties of the first unlabeled dataset; using the first set of labels and the first unlabeled dataset, generating a labeled training dataset; using the labeled training dataset, training a reinforcement learning model to identify abnormalities and changes to statistical distributions within data; and using the reinforcement learning model, processing a second unlabeled dataset to generate a second set of labels associated with statistical properties of the second unlabeled dataset.
3. A method comprising: processing a first unlabeled dataset using a first machine learning model to generate a first set of labels associated with statistical properties of the first unlabeled dataset; using the first set of labels and the first unlabeled dataset, generating a labeled training dataset; using the labeled training dataset, training a second machine learning model to identify abnormalities and changes to statistical distributions within data; and using the second machine learning model, processing a second unlabeled dataset to generate a second set of labels associated with statistical properties of the second unlabeled dataset.
4. The method of any one of the preceding embodiments, wherein: the first unlabeled dataset comprises time-series data; and the unsupervised model uses a Bayesian network to perform changepoint detection on time-series data and generate timestamps corresponding to points in time-series data where a statistical distribution has shifted.
5. The method of any one of the preceding embodiments, further comprising: receiving raw training data; partitioning the raw training data into a first portion associated with a first weight score and a second portion associated with a second weight score; training a first model using the first portion of the raw training data to obtain a first set of model parameters; training a second model using the second portion of the raw training data to obtain a second set of model parameters; and generating the unsupervised model by combining the first set of model parameters and the second set of model parameters based on the first weight score and the second weight score.
6. The method of any one of the preceding embodiments, further comprising: receiving raw training data; selecting a first model for unsupervised learning and a second model for unsupervised learning; training the first model using the raw training data to obtain a first set of model parameters; training a second model using the raw training data to obtain a second set of model parameters; and generating the unsupervised model by combining the first set of model parameters and the second set of model parameters based on a first bias metric.
7. The method of any one of the preceding embodiments, further comprising: based on a performance metric of the reinforcement learning model, updating the first bias metric to generate a second bias metric; and updating the unsupervised model by combining the first set of model parameters and the second set of model parameters based on the second bias metric.
8. The method of any one of the preceding embodiments, further comprising: receiving raw training data; selecting a first model for unsupervised learning and a second model for unsupervised learning; training the first model using the raw training data to obtain a first set of model parameters; determining a first cross-validation error score associated with the first set of model parameters, wherein the first cross-validation error score is indicative of a degree of fit between the first model and the raw training data; training a second model using the raw training data to obtain a second set of model parameters; determining a second cross-validation error score associated with the second set of model parameters, wherein the second cross-validation error score is indicative of a degree of fit between the second model and the raw training data; and generating the unsupervised model by combining the first set of model parameters and the second set of model parameters based on the first cross-validation error score and the second cross-validation error score.
9. The method of any one of the preceding embodiments, further comprising: combining the first unlabeled dataset with synthetic data to generate an augmented unlabeled dataset, wherein the synthetic data is representative of hypothetical scenarios not included in the first unlabeled dataset; processing the augmented unlabeled dataset using the unsupervised model to generate an expanded set of labels; using the expanded set of labels and the augmented unlabeled dataset, generate an expanded training dataset; and using the expanded training dataset, training the reinforcement learning model.
10. The method of any one of the preceding embodiments, further comprising: presenting the second set of labels to a set of users; obtaining a set of feedback from the set of users, wherein the set of feedback is indicative of a degree of suitability of the second set of labels to the second unlabeled dataset; using the set of feedback, generate a second training dataset, wherein the second training dataset is labeled using the set of feedback; and updating the reinforcement learning model based on the second training dataset.
11. The method of any one of the preceding embodiments, wherein the reinforcement learning model performs changepoint detection using a Q-learning algorithm.
12. The method of any one of the preceding embodiments, wherein the reinforcement learning model performs anomaly detection using a deep reinforcement learning algorithm.
13. One or more non-transitory computer-readable media comprising instructions that, when executed by a data processing apparatus, cause the data processing apparatus to perform operations comprising those of any of embodiments 1-12.
14. A system comprising one or more processors; and one or more non-transitory, computer-readable media comprising instructions that, when executed by the one or more processors, cause operations comprising those of any of embodiments 1-12.
15. A system comprising means for performing any of embodiments 1-12.

What is claimed is:

1. A system for training a reinforcement learning model using training data generated using an unsupervised model, comprising:
one or more processors; and
one or more non-transitory, computer-readable media comprising instructions that, when executed by the one or more processors, cause operations comprising:
receiving a first time-series dataset;
processing the first time-series dataset using an unsupervised model to generate a set of changepoints in the first time-series dataset;
using the first time-series dataset and the set of changepoints, generating a first training dataset;
using the first training dataset, training a reinforcement learning model to identify changepoints in time-series data; and
using the reinforcement learning model, processing a second time-series dataset to generate one or more notifications comprising changepoints in the second time-series dataset.

2. A method for training a reinforcement learning model using training data generated using an unsupervised model, the method comprising:
processing a first unlabeled dataset using an unsupervised model to generate a first set of labels associated with statistical properties of the first unlabeled dataset;
using the first set of labels and the first unlabeled dataset, generating a labeled training dataset;
using the labeled training dataset, training a reinforcement learning model to identify abnormalities and changes to statistical distributions within data; and
using the reinforcement learning model, processing a second unlabeled dataset to generate a second set of labels associated with statistical properties of the second unlabeled dataset.

3. The method of claim 2, wherein:
the first unlabeled dataset comprises time-series data; and
the unsupervised model uses a Bayesian network to perform changepoint detection on time-series data and generate timestamps corresponding to points in time-series data where a statistical distribution has shifted.

4. The method of claim 2, further comprising:
receiving raw training data;
partitioning the raw training data into a first portion associated with a first weight score and a second portion associated with a second weight score;
training a first model using the first portion of the raw training data to obtain a first set of model parameters;
training a second model using the second portion of the raw training data to obtain a second set of model parameters; and
generating the unsupervised model by combining the first set of model parameters and the second set of model parameters based on the first weight score and the second weight score.

5. The method of claim 2, further comprising:
receiving raw training data;
selecting a first model for unsupervised learning and a second model for unsupervised learning;
training the first model using the raw training data to obtain a first set of model parameters;
training a second model using the raw training data to obtain a second set of model parameters; and
generating the unsupervised model by combining the first set of model parameters and the second set of model parameters based on a first bias metric.

6. The method of claim 5, further comprising:
based on a performance metric of the reinforcement learning model, updating the first bias metric to generate a second bias metric; and
updating the unsupervised model by combining the first set of model parameters and the second set of model parameters based on the second bias metric.

7. The method of claim 2, further comprising:
receiving raw training data;
selecting a first model for unsupervised learning and a second model for unsupervised learning;
training the first model using the raw training data to obtain a first set of model parameters;
determining a first cross-validation error score associated with the first set of model parameters, wherein the first cross-validation error score is indicative of a degree of fit between the first model and the raw training data;
training a second model using the raw training data to obtain a second set of model parameters;
determining a second cross-validation error score associated with the second set of model parameters, wherein the second cross-validation error score is indicative of a degree of fit between the second model and the raw training data; and
generating the unsupervised model by combining the first set of model parameters and the second set of model parameters based on the first cross-validation error score and the second cross-validation error score.

8. The method of claim 2, further comprising:
combining the first unlabeled dataset with synthetic data to generate an augmented unlabeled dataset, wherein the synthetic data is representative of hypothetical scenarios not included in the first unlabeled dataset;
processing the augmented unlabeled dataset using the unsupervised model to generate an expanded set of labels;
using the expanded set of labels and the augmented unlabeled dataset, generate an expanded training dataset; and
using the expanded training dataset, training the reinforcement learning model.

9. The method of claim 2, further comprising:
presenting the second set of labels to a set of users;
obtaining a set of feedback from the set of users, wherein the set of feedback is indicative of a degree of suitability of the second set of labels to the second unlabeled dataset;
using the set of feedback, generate a second training dataset, wherein the second training dataset is labeled using the set of feedback; and
updating the reinforcement learning model based on the second training dataset.

10. The method of claim 2, wherein the reinforcement learning model performs changepoint detection using a Q-learning algorithm.

11. The method of claim 2, wherein the reinforcement learning model performs anomaly detection using a deep reinforcement learning algorithm.

12. One or more non-transitory computer-readable media comprising instructions that, when executed by one or more processors, cause operations comprising:
processing a first unlabeled dataset using a first machine learning model to generate a first set of labels associated with statistical properties of the first unlabeled dataset;
using the first set of labels and the first unlabeled dataset, generating a labeled training dataset;
using the labeled training dataset, training a second machine learning model to identify abnormalities and changes to statistical distributions within data; and
using the second machine learning model, processing a second unlabeled dataset to generate a second set of labels associated with statistical properties of the second unlabeled dataset.

13. The one or more non-transitory computer-readable media of claim 12, wherein:
the first unlabeled dataset comprises time-series data; and
the first machine learning model uses a Bayesian network to perform changepoint detection on time-series data and generate timestamps corresponding to points in time-series data where a statistical distribution shifted.

14. The one or more non-transitory computer-readable media of claim 12, further comprising:
receiving raw training data;
partitioning the raw training data into a first portion associated with a first weight score and a second portion associated with a second weight score;
training a first model using the first portion of the raw training data to obtain a first set of model parameters;
training a second model using the second portion of the raw training data to obtain a second set of model parameters; and
generating the first machine learning model by combining the first set of model parameters and the second set of model parameters based on the first weight score and the second weight score.

15. The one or more non-transitory computer-readable media of claim 12, further comprising:
receiving raw training data;
selecting a first model for unsupervised learning and a second model for unsupervised learning;
training the first model using the raw training data to obtain a first set of model parameters;
training a second model using the raw training data to obtain a second set of model parameters; and
generating the first machine learning model by combining the first set of model parameters and the second set of model parameters based on a first bias metric.

16. The one or more non-transitory computer-readable media of claim 15, further comprising:
based on a performance metric of the second machine learning model, updating the first bias metric to generate a second bias metric; and
updating the first machine learning model by combining the first set of model parameters and the second set of model parameters based on the second bias metric.

17. The one or more non-transitory computer-readable media of claim 12, further comprising:
receiving raw training data;
selecting a first model for unsupervised learning and a second model for unsupervised learning;
training the first model using the raw training data to obtain a first set of model parameters;
determining a first cross-validation error score associated with the first set of model parameters, wherein the first cross-validation error score is indicative of a degree of fit between the first model and the raw training data;
training a second model using the raw training data to obtain a second set of model parameters;
determining a second cross-validation error score associated with the second set of model parameters, wherein the second cross-validation error score is indicative of a degree of fit between the second model and the raw training data; and
generating the first machine learning model by combining the first set of model parameters and the second set of model parameters based on the first cross-validation error score and the second cross-validation error score.

18. The one or more non-transitory computer-readable media of claim 12, further comprising:
combining the first unlabeled dataset with synthetic data to generate an augmented unlabeled dataset, wherein the synthetic data is representative of hypothetical scenarios not included in the first unlabeled dataset;
processing the augmented unlabeled dataset using the first machine learning model to generate an expanded set of labels;
using the expanded set of labels and the augmented unlabeled dataset, generate an expanded training dataset; and
using the expanded training dataset, training the second machine learning model.

19. The one or more non-transitory computer-readable media of claim 12, further comprising:
presenting the second set of labels to a set of users;
collecting a set of feedback from the set of users, wherein the set of feedback is indicative of a degree of suitability of the second set of labels to the second unlabeled dataset;
using the set of feedback, generate a second training dataset, wherein the second training dataset is labeled using the set of feedback; and
updating the second machine learning model based on the second training dataset.

20. The one or more non-transitory computer-readable media of claim 12, wherein the second machine learning model performs changepoint detection using a Q-learning algorithm.
